(19) United States
(12) Patent Application Publication
(10) Pub. No.: US 2007/0297187 A1
(43) Pub. Date: Dec. 27, 2007

(54) Lamp socket assembly

(76) Inventor: Peter Tsai, Taipei (TW)

Correspondence Address: COOPER & DUNHAM, LLP, 1185 AVENUE OF THE AMERICAS, NEW YORK, NY, 10036, US

(21) Appl. No.: 11/474,715

(22) Filed: Jun. 26, 2006

(51) Int. Cl. F21V 17/06

(52) U.S. Cl. 362/443

(57) ABSTRACT

A lamp socket assembly has a casing, a base, at least one reflective element and at least one light bulb. The casing has a cavity and at least one electrical socket mounted in the cavity. The base has at least one recess formed through the base. The reflective elements detachably mounted respectively in the recesses respectively around the electrical sockets. The light bulbs are mounted respectively in the electrical sockets and the reflective elements. When the lamp socket assembly is recycled, the reflective element can be easily detached from the base, to keep from producing toxic gases.

### BACKGROUND OF THE INVENTION

1. Field of the Invention

The present invention relates to a lamp, and more particularly to a lamp socket assembly that is easy to manufacture and allows parts to be recycled conveniently.

2. Description of Related Art

Lamp socket assemblies hold and provide electricity to light bulbs. A conventional lamp socket assembly comprises a base, a socket and a selective cover. The base typically has a recess and two electrical contacts formed in the recess. The recess is formed in the base to hold a socket and a light bulb, is coated with a reflective coating to reflect light from the socket assembly. The reflective coating typically contains mercury or tin. The selective cover is transparent and can be mounted on the base over the recess for protection of the bulbs.

A light bulb can be mounted in a corresponding recess and connected to the electrical contacts of the corresponding recess for providing of electricity.

However, conventional lamp socket assemblies as described have the following disadvantages. When the lamp socket assemblies are eventually disassembled for recycling, the reflective coating in the recess in the base must be removed to keep the reflective coating from producing toxic gas in the recycling process. Removing the reflective coating is tedious and inconvenient and can be costly.

To overcome the shortcomings, the present invention provides an improved lamp socket assembly to obviate or mitigate the aforementioned problems.

### SUMMARY OF THE INVENTION

The main objective of the invention is to provide a lamp socket assembly that can be recycled conveniently.

The lamp socket assembly in accordance with the present invention mainly comprises a base, at least one reflective element and at least one light bulb. The base has at least one recess. Instead of a reflective coating as used in a conventional lamp socket assembly, the reflective elements are detachably mounted respectively in the recesses.

When the lamp socket assembly to be recycled, the reflective element can be easily detached and removed from the base, to make recycling more convenient and prevent toxic gas from being produced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lamp socket assembly in accordance with the present invention;

FIG. 2 is an exploded perspective view of the lamp socket assembly in FIG. 1;

FIG. 3 is an exploded perspective view of a second embodiment of a lamp socket assembly in accordance with the present invention;

FIG. 4 is a top view of reflective elements used in the lamp socket assembly in FIG. 2 stamped on a plate; and

FIG. 5 is a top view of reflective elements used in the lamp socket assembly in FIG. 3 stamped on a plate.

### DETAILED DESCRIPTION OF THE PREFERRED EMBODIMENT

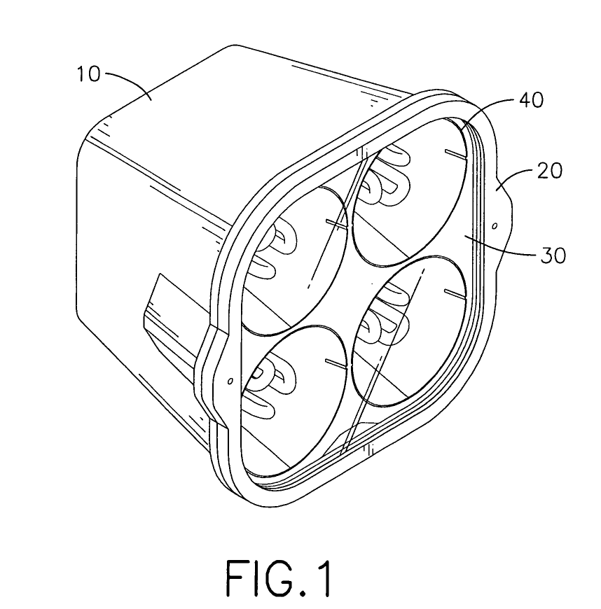

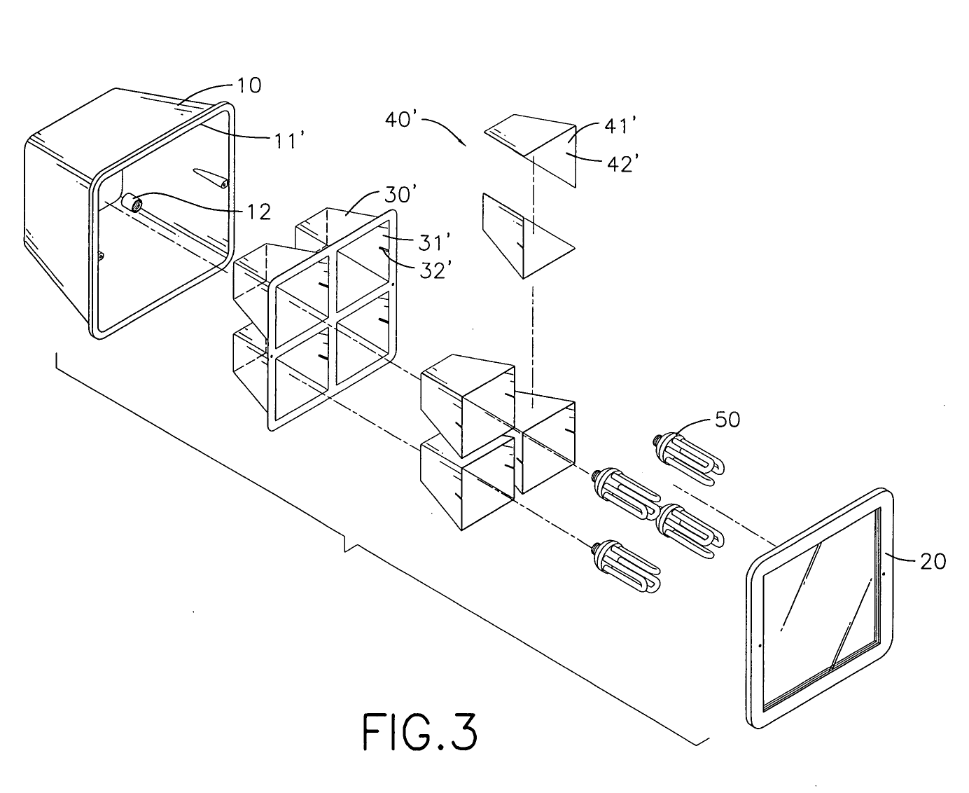

With reference to FIGS. 1 and 3, a lamp socket assembly in accordance with the present invention comprises a casing (10), a base (30, 30′), at least one reflective element (40, 40′), at least one light bulb (50) and an optional cover (20).

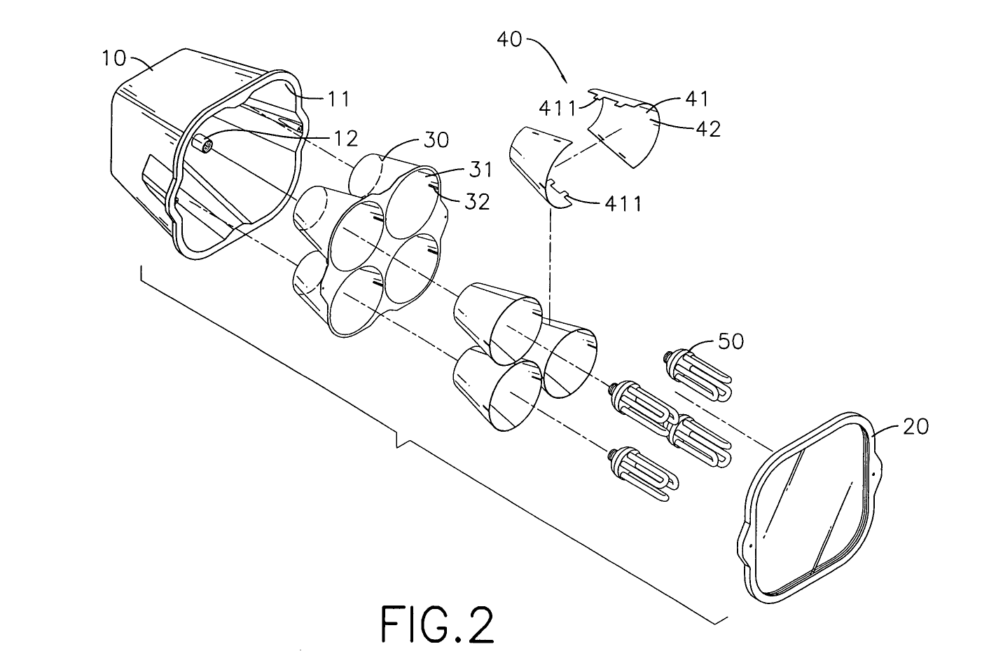

With further reference to FIG. 2, the casing (10) has an outer edge, a cavity (11, 11′) and at least one electrical lamp socket (12). The cavity (11, 11′) is defined through the outer edge and has a bottom. The at least one electrical lamp socket (12) is mounted on the bottom of the cavity (11, 11′) and has at least two electrical contacts.

The base (30, 30′) is mounted in the cavity (11) and has an outer edge and at least one recess (31, 31′). The at least one recess (31, 31′) is defined through the outer edge of the base (30, 30′) and corresponds respectively to the at least one electrical lamp socket (12). Each recess (31, 31′) has an outer opening, an inner opening, an inner surface and two optional fasteners (32, 32′). The inner opening is mounted around a corresponding electrical lamp socket (12). The inner surface is a frustum of a cone or a pyramid. The two fasteners (32, 32′) are formed opposite to each other on the inner surface near the outer opening.

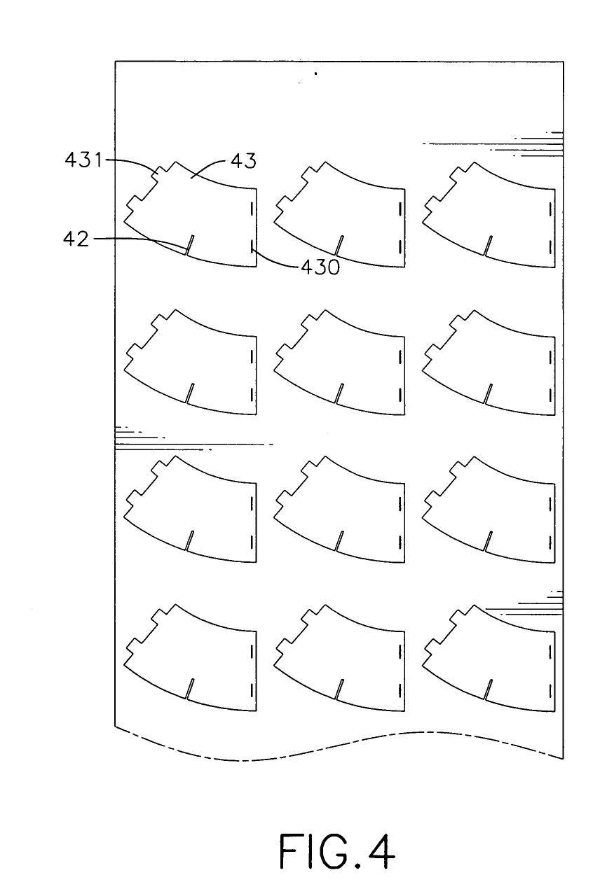

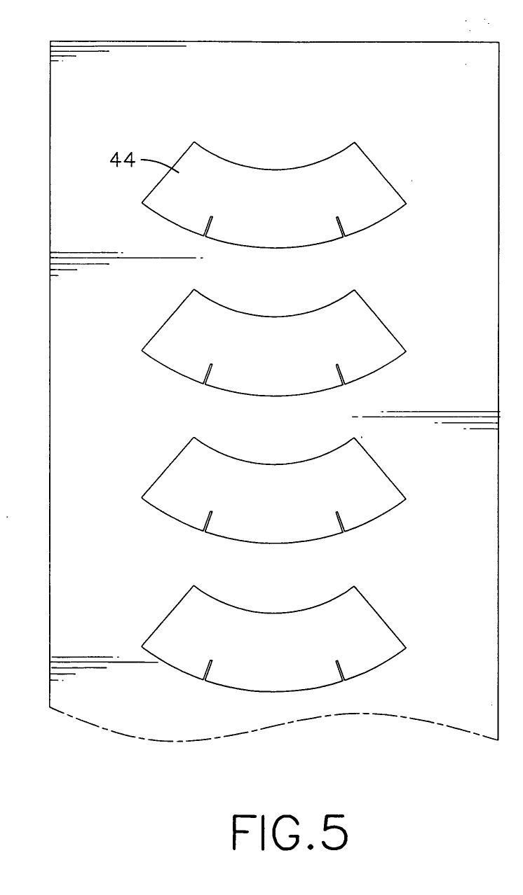

With further reference to FIGS. 4 and 5, the reflective elements (40, 40′) correspond respectively to and are mounted respectively in a corresponding recess (31, 31′) in the base (30, 30′) and may be stamped from sheet metal. The sheet metal may have a shiny surface or be coated with reflective material such as mercury or tin. Each reflective element (40, 40′) is frustum of a cone or a pyramid, may be formed from two reflective sections (43) or a single reflective section (44) and has a reflective inner surface (41, 41′) and two optional mounting slots (42, 42′). Each reflective section (43, 44) has two side edges, two optional connecting slots (430) and two optional connecting tabs (431). The side edges of an adjacent reflective section (43) are connected to a side edge of an adjacent reflective section (43). The side edges of the reflective section (44) are connected to an opposite side edge of or the opposite side edge of the same reflective section (44) by welding, soldering or other appropriate technique to form the frustum. The connecting slots (430) are formed adjacent to one side edge. The connecting tabs (431) are formed on and protrude from the opposite side edge, correspond to the connecting slots (430) and are mounted respectively in the connecting slots (430) on an adjacent side edge to connect the side edges of the adjacent reflective sections (43). The reflective inner surface (41, 41′) is inside the frustum and reflects light. The mounting slots (42, 42′) are defined through the reflective inner surface (41, 41′) and correspond respectively to and engage the fasteners (32, 32′) in a corresponding recess (31, 31′) in the base (30, 30′). The mounting slots (42, 42′) can be detached easily from the fasteners (32, 32′) by slightly bending the reflective elements (40, 40′) and removing the reflective elements (40, 40′) from the base (30, 30′).

The light bulbs (50) are mounted respectively in the lamp sockets (12) inside the recesses (31, 31′) in the base (30, 30′) to generate and emit light.

The cover (20) connects detachably to the outer edge of the casing (10), covers and protects the light bulbs (50) and has a transparent face. The transparent face allows light emitted by the light bulbs (50) and reflected by the reflective inner surfaces (41, 41′) of the reflective elements (40, 40′) to radiate from the lamp socket assembly.

Since the reflective elements (40, 40′) can be detached easily from the base (30, 30′) by disengaging the mounting slots (32, 32′) from the fasteners (42, 42′), the lamp socket assembly can be recycled easily without fear of generating toxic gases.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A lamp socket assembly comprising
a casing having
an outer edge;
a cavity being defined through the outer edge and having a bottom; and
at least one electrical lamp socket being mounted on the bottom of the cavity;
a base being mounted in the cavity and having
an outer edge; and
at least one recess being defined through the outer edge of the base and each one of the at least one recess having
an outer opening; and
an inner opening being mounted around a corresponding electrical lamp socket;
at least one reflective element corresponding respectively to and being mounted detachably in the at least one recess of the base, and each one of the at least one reflective element having a reflective inner surface; and
at least one light bulb being mounted respectively in the at least one lamp socket inside the at least one recess in the base.

2. The lamp socket assembly as claimed in claim 1, wherein
each one of the at least one recess in the base further has two fasteners formed opposite to each other on the inner surface near the outer opening; and
each one of the at least one reflective element further has two mounting slots defined through the reflective inner surface and corresponding respectively to and engaging the fasteners in a corresponding recess in the base.

3. The lamp socket assembly as claimed in claim 2, wherein each one of the at least one reflective element is a frustum of a cone.

4. The lamp socket assembly as claimed in claim 2, wherein each one of the at least one reflective element is a frustum of a pyramid.

5. The lamp socket assembly as claimed in claim 2 further comprising a cover connecting detachably to the outer edge of the casing, covering and protecting the at least one light bulb and having a transparent face.

6. The lamp socket assembly as claimed in claim 2, wherein each one of the at least one reflective element is formed from two reflective sections.

7. The lamp socket assembly as claimed in claim 2, wherein each one of the at least one reflective element is formed from a single reflective element section.
